(19) United States
(12) Patent Application Publication
(10) Pub. No.: US 2002/0138307 A1
(43) Pub. Date: Sep. 26, 2002

(54) Process for auditing insurance underwriting

(76) Inventor: Andrew J. Kramer, Leawood, KS (US)

Correspondence Address: SHUGHART THOMSON & KILROY, PC, 120 WEST 12TH STREET, KANSAS CITY, MO, 64105, US

(21) Appl. No.: 09/681,370

(22) Filed: Mar. 26, 2001

(51) Int. Cl. G06F 17/60

(52) U.S. Cl. 705/4

(57) ABSTRACT

A process for auditing insurance underwriting investigations and underwriting decisions wherein if the underwriter determines that the underwriter deviated from established rules whether the underwriter documented the decision to do so and whether the decision to deviate from established rules falls within established guidelines. If the decision to deviate from established rules was documented and the decision was within guidelines the underwriting investigation and the underwriting decision are still scored as appropriate.

### BACKGROUND OF INVENTION

The present invention relates to a process for auditing the underwriting process of insurance underwriters, and in particular a method of determining whether an underwriter is properly performing their duties within acceptable guidelines.

Generally, the purpose of insurance is to distribute the costs of the potential risks of a number of individual persons or companies over a large “pool” of such persons or companies. The insurer indemnifies each insured against a limited level of loss from a specified risk or risks. In return, each insured pays a “premium”, the premiums being pooled and invested to provide funds to pay for settlements of claims, when and if necessary. Insurers use historical data, financial information, statistics, and information from other sources to gauge the amount of premiums paid by each insured against the aggregate losses of the pool of insureds. There are also regulatory aspects to setting premium rates.

If an insurer's income from premiums exceeds payouts for claims, the insurer makes a profit. However, in a competitive insurance market, an insurer must limit premiums charged to the minimums required to cover any claims, overhead, and a modest profit. Thus, it is advantageous to an insurer to assess, as accurately as possible, the frequency and severity of any risks which it insures against and to charge premiums closely gauged to the probable payout which may be required.

Individual decisions on whether or not to insure a particular risk and if so under what terms and conditions are made by underwriters. The underwriters have established rules to follow in making underwriting decisions. However, it is generally recognized that underwriters should be allowed to exercise some discretion in making exceptions to the rules or that a certain amount of flexibility and latitude should be built into the rules to allow independent judgment by the underwriter in addressing the numerous variations encountered in the underwriting process. To the extent exceptions to the rules are permitted, guidelines are usually provided to guide the underwriter in making appropriate decisions.

Despite the critical role underwriter's play in the success or failure of an insurance company, heretofore there have not been adequate tools for evaluating the competency or job performance of an underwriter. One might think a company could simply look at the number and dollar amount of claims made on policies reviewed by a particular underwriter to evaluate the underwriter's performance. Unfortunately, by the time such data becomes available, the damage caused by poor underwriting decisions already have been done. Such a situation is particularly true in the case of life insurance where claims typically are not made for many years after the initial underwriting.

In an effort to evaluate the performance of an underwriter, most insurance companies will therefore audit the underwriting decisions made by an underwriter to determine whether or not the underwriter followed the established rules. Unfortunately, known systems focus solely on whether or not the underwriter followed the rules. The known systems do not provide a means for evaluating whether or not the underwriter used sound judgment in granting exceptions to the rules. Such existing auditing systems encourage blind adherence to the underwriting rules and discourage valuable creativity in applying the rules to increase revenue without increasing risks. There remains a need for an improved system for auditing underwriters which rewards sound decision making by underwriters in the underwriting process.

The underwriting decision audit process described below is done in the context of the underwriting of life insurance policies and with reference to the underwriting by an underwriter for a reinsurer. Reinsurance is used by insurance companies to redistribute their exposure to other insurers. In a reinsurance agreement, an insurer, often referred to as a primary insurer or ceding company, transfers or cedes some or all of its exposures and premiums to a reinsurer. The reinsurer then agrees to indemnify the ceding company for a predetermined type and amount of losses sustained.

The skill of the reinsurance underwriter is critical in ensuring that the reinsurer reaps the benefits of being willing to reinsure potentially riskier policies in exchange for a higher premium or rate. Criteria are developed by companies to allow the underwriter to calculate approved rates or ratings for individuals based upon an analysis of relevant risk factors including the age, sex and medical history of the insured, occupational or recreational hazards, lifestyle factors such as whether the insured smokes and the amount of insurance sought versus the net worth or earning potential of the applicant.

A base or standard rating for an individual is based upon the individual's age and sex. Additional risk factors present are generally assigned a numerical value to be added to the base rating. As the additional risk factors increase the base rating above set points, the rate, rating or premium is increased accordingly. For example, for every twenty-five point increase over the standard rating due to additional risk factors present, the premium would increase by twenty five percent (25%). These incremental increases are often referred to as tables. For applicants who are rated table 2, their cost of insurance will be 150% of standard rates.

In an effort to attract business or in an effort to beat a competitor's offer on a rated applicant (i.e. applicants rated or priced higher than standard),ceding underwriters will often try to obtain a more favorable rating for the potential insured by “shopping” the case or sending it to numerous reinsurers, resulting in a lower premium. The reinsurance underwriter must determine under what terms the reinsurer is willing to offer to cover the risks. The terms generally include the rating (which determines premiums) and the amount of coverage sought or the reinsurer's participation in the amount of coverage sought. The ultimate goal of the underwriter is to make an offer to provide coverage, but in exchange for an acceptable premium commensurate with the risk involved and without excessive exposure in the amount of coverage provided.

FIG. 1, is representative of the procedure of existing underwriting audit processes. The auditor obtains and reviews at 1 the underwriter's file. The auditor then evaluates at 2 whether the file indicates that the investigative work-up by the underwriter was complete and in compliance with established norms for obtaining necessary information. If the investigative work-up is not in compliance with established requirements, the auditor reports the investigative work-up as defective at 3. If the investigative work-up is in compliance with established requirements, it is reported as appropriate at 4.

The underwriter then evaluates at 6 whether the underwriting was appropriate. Such a decision is limited to whether or not the offered rate is within established company norms based upon known risk factors, or within an acceptable range of rates. If the rate at which the policy was offered was not within established rates or the acceptable range, then the underwriting is reported as defective at 7. If the rating is within the acceptable range of the norms then the underwriting is reported as appropriate at 8.

In the life insurance context, the investigative work-up focuses on identifying risk factors which might negatively effect life expectancies. The risk factors relied on focus primarily on medical conditions or medical history, risky occupations or avocations and the amount of insurance sought in comparison to the insured's net worth or earning potential. In underwriting the policy, the underwriter evaluates the risk factors identified in the investigative work-up and assigns a risk rating to the applicant. Using company established guidelines, the underwriter determines whether the proposed rate is acceptable or provides an acceptable rate.

The emphasis placed on strict compliance with established rules under existing underwriting audit decision processes discourages creativity and discretionary decision making by underwriters in an effort to limit adverse exposure. This however, results in lower placement rates, less premium and dissatisfied customers who are looking for coverage.

### SUMMARY OF INVENTION

The process for auditing underwriting processes and decisions disclosed herein extends the analysis of whether the underwriting process and decisions were in accordance with the rules and establishes a system for evaluating and tracking whether any exceptions to the rules were made within established guidelines and with appropriate documentation.

To perform the underwriting audit, the auditor first obtains a copy of the underwriter's file for each policy to be audited. The file includes a record from the underwriter of the decisions made by the underwriter in underwriting a policy. The auditing process focuses on several aspects of the underwriter's job, including the investigative work-up for the risk to be insured and the decisions made by the underwriter in underwriting the policy at issue.

In auditing the investigative work-up, the auditor makes an initial determination of whether the investigative work-up was appropriate. If the underwriter followed all of the rules regarding the work-up without any deviation, the auditor scores the work-up as “within guidelines” or appropriate and then proceeds to the step of determining whether the underwriting decisions made by the underwriter were in accordance with the established rules. If all of the underwriting decisions were made in accordance with the rules, the auditor scores the underwriting decision as “within guidelines” or appropriate. These scores are then recorded in a database and associated with the underwriter and with the particular policy. Although preferably in an electronic format, the data may also be compiled in a paper format.

Returning to the audit of the work-up, if the underwriter deviated from the rules regarding the investigative work-up, the auditor then determines whether the business decision justifying the deviation was properly documented. The business decision would be considered properly documented if the underwriter documented that he or she intentionally deviated from the rules and provided a rationale or justification for the deviation. If the underwriter did not document that a business decision was made, the auditor scores the investigative work-up by the underwriter as defective, and then proceeds to the audit of the underwriting decision. If the business decision for the variation of the investigative work-up was documented, then the auditor must determine if the business decision falls within established guidelines. If not, the auditor scores the investigative work-up business decision as defective, and then proceeds to the audit of the underwriting decision. If the business decision is found to be within guidelines, the auditor scores the investigative work-up as “within guidelines” or appropriate and proceeds to the step of auditing the underwriting decisions.

If, in the initial step of the audit of the underwriting decision, the auditor determines that the underwriter deviated from the rules governing underwriting decisions, the auditor then determines whether the underwriter intentionally made a business decision to deviate from the rules which was properly documented. If not, the auditor scores the underwriting as defective. If the business decision for the variation from the underwriting rules was properly documented, then the auditor must determine if the business decision falls within established guidelines. If not, the auditor scores the business decision for the underwriting as defective. If the underwriting business decision is found to be within guidelines, the auditor scores the underwriting as “within guidelines” or appropriate.

As noted previously, these scores are then recorded in a database and associated with the underwriter and the policy. The scores for each underwriter may then be tabulated and compared to a standard or the other scores. The process can therefore be used to more effectively evaluate the performance of underwriters.

### BRIEF DESCRIPTION DRAWINGS

FIG. 1 is a flow chart showing the general steps in existing underwriting auditing procedures.

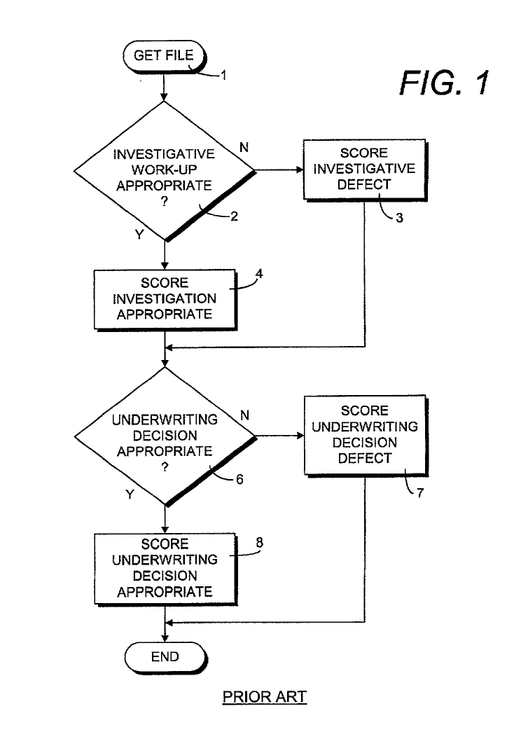

FIG. 2 is a process diagram showing the principal steps of an underwriting decision auditing process.

FIG. 3 is a diagramatic view of a screen display for recording information and scores relating to the underwriting audit.

### DETAILED DESCRIPTION

As required, detailed embodiments of the present invention are disclosed herein; however, it is to be understood that the disclosed embodiments are merely exemplary of the invention, which may be embodied in various forms. Therefore, specific procedural and functional details disclosed herein are not to be interpreted as limiting, but merely as a basis for the claims and as a representative basis for teaching one skilled in the art to variously employ the present invention in virtually any appropriately detailed process.

For exemplary purposes, the underwriting decision audit process is described with reference to the underwriting of life insurance policies by a reinsurance underwriter. The audit process is performed by an underwriter, preferably with demonstrated expertise.

In one aspect of the auditing process, the underwriter evaluates whether the underwriter conducted an appropriate investigation of the potential risks and whether the ultimate underwriting decision on whether to approve coverage at a specified rate was appropriate. With reference to life insurance underwriting, the audit may review the appropriateness of: the investigative work-up of the insured's medical history and financial information, the medical/nonmedical underwriting decisions, and the financial underwriting decisions. Other underwriting aspects reviewed and taken into consideration include the need for obtaining second opinions on electrocardiograms (EKGs), the need for obtaining a second underwriter's signature, proper application of retrocession rules; documentation of the underwriting decisions including the appropriateness of the underwriting notes, memos and correspondence to support any deviation from the general underwriting rules. In addition, the audit can address customer service issues including whether the underwriter's response was timely.

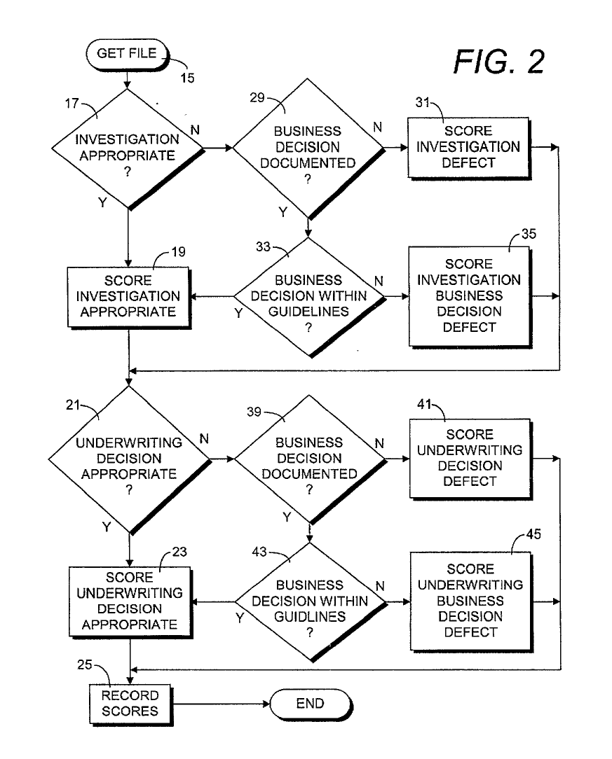

FIG. 2 provides an overview of the auditing process. As an initial step 15 of the auditing process, as shown in FIG. 2, the auditor obtains a copy of the underwriter's file relating to a particular policy or insurance contract. The file should provide documentation of the decision made by the underwriter to approve the policy at a requested rate.

The auditor then reviews the file to determine at 17 whether, the investigative work-up was appropriate and followed established rules for such work-ups. If the underwriter followed all of the rules regarding the work-up without any deviation, the auditor scores the work-up at 19 as “within guidelines” or appropriate and then proceeds to step 21 to determine whether the underwriting decisions made by the underwriter were in accordance with the established rules. If all of the underwriting decisions were made in accordance with the rules, then the auditor scores the underwriting decision at 23 as “within guidelines” or appropriate. These scores are then recorded at 25 in a database and associated with the underwriter, which may be in paper or electronic form or both.

Returning to the audit of the work-up, if it is determined at step 17, that the underwriter deviated from the rules regarding the investigative work-up, then at step 29, the auditor determines whether it was documented that the underwriter made a business decision to do so. If not, the auditor scores the investigative work-up as defective at step 31, and then proceeds to the audit of the underwriting decision at step 21.

If the business decision for the variation of the investigative work-up was documented, then the auditor must determine, at step 33, whether the business decision falls within established guidelines. If not, the auditor scores the investigation business decision as defective at step 35, and then proceeds to the audit of the underwriting decision at step 21. If the business decision is found, at step 33, to be within guidelines, the auditor scores the investigative work-up at step 19 as “within guidelines” or appropriate and proceeds to the auditing the underwriting decisions at step 21.

If it is determined at step 21 that the underwriter deviated from the rules governing underwriting decisions, the auditor then determines at step 39 whether the underwriter documented that a business decision was made to do so. If not, the auditor scores the underwriting decision as defective at step 41. If the business decision for the variation from the underwriting rules was documented, then the auditor must determine at step 43 if the business decision falls within established guidelines. If not, the auditor scores the underwriting business decision as defective at step 45. If, at step 43, the business decision is found to be within guidelines, the auditor scores the underwriting decision as “within guidelines” or appropriate at step 23.

As noted previously, these scores are then recorded at step 25 in a database and associated with the underwriter. The scores for each underwriter may then be tabulated and compared to a standard or the other scores. The process can therefore be used to more effectively evaluate the performance of underwriters.

As noted previously, the methodology generally shown in the process diagram of FIG. 2, may be utilized for auditing underwriting decisions related to the issuance of or reinsurance of life insurance policies. Utilization of the auditing process requires establishment of guidelines for determining whether decisions by the underwriters to deviate from established rules or standards are appropriate. Although the auditing process is intended not to discourage creativity and allow underwriter discretion, the guidelines establish limits to the use of such discretion or guidance as to when use of such discretion may be appropriate.

Provided hereafter are exemplary guidelines utilized in life insurance underwriting by an underwriter for a reinsurance company. A business decision to deviate from established rules is not to be made for applicants over age seventy five. A second signature is required on any decision to offer a policy at a rate that differs from an established rate by more than three tables. The second signature should be from an underwriting manager or supervisor, if available, or to an underwriter with equal or greater approval authority. For offers in which the rate exceeds an established rate by up to three tables, the reinsurer's participation should not exceed two times the retention of the primary insurer through age 75 of the applicant. In addition, no deviation will typically be deemed appropriate on a single life case when the original assessment by the reinsurer was to decline. However, if the case is joint survivor coverage (i.e. two lives covered in one policy), an exception may be made on the declined life provided the second life is within an acceptable risk rating. The guidelines also preferably permit deviations from established rules when appropriate to accommodate the requests of good clients. For example, some discretion is permitted where the client places a significant amount of business with the reinsurer or insurer, or for clients which do not frequently request exceptions or reduced rates.

Revisiting the appropriateness of the investigative work-up, rules or requirements for the investigative work-up are generally established by the insurer or reinsurer. Typical requirements for a reinsurance underwriter to follow or cover in the investigative work-up are provided below. When investigating financial information, the underwriter should obtain third party verification of finances or follow the ceding company's financial documentation guidelines for large face amounts. If the amount approved exceeds $5 million, a financial source in an inspection report will suffice. If the amount approved exceeds $10 million, credible third party financial validation will be required.

Typical requirements for investigating medical history include reliance on medical history reports and lab reports that are not more than six months old. For applicants who are fifty five or younger, with no reported risk factors in their medical history, a normal stress EKG less than two years old should be included in the file. For applicants over age fifty five, the file should include a stress EKG which is not more than twelve months old. The underwriter should obtain an attending physician's statement if there is evidence of any unexplained exams or doctors visits within three months of the application date; if there is any indication of a potentially ratable medical impairment; or if there was a doctor visit after the last attending physician's statement. For applicants who are age eighty or over, an attending physician's statement is required to include a full physical exam within the last twelve months. The underwriter's report should indicate that the underwriter checked a medical history clearinghouse service (i.e. Medical Information Bureau) to attempt to identify medical history information for the applicant. In addition if such a report includes a code which suggests additional mortality, the file should document that the additional mortality was investigated.

To assist in understanding the application of the auditing process, consider a case in which a well known athlete, 30 years old, seeks $20,000,000 in life insurance. The information provided by the athlete and the investigation of the athlete's medical history indicate the proposed rate or rating is acceptable and the only additional information which the rules would require the underwriter to obtain is third party validation of the applicant's financials. The underwriter is familiar with the athlete and generally familiar with salary ranges for similarly situated athletes. The financial information provided by the athlete appears consistent with the underwriter's knowledge of what the athlete's earnings might be. Therefore the underwriter decides not to ask for third party validation of the athletes financials. This decision is done in part to avoid delays in processing the application to avoid losing the customer to another reinsurer. The underwriter records in the file the exception or business decision made and the basis for the exception.

In evaluating whether the investigative work-up was appropriate (step 17, FIG. 2), the auditor would determine that the work-up was not appropriate. However, because the business decision to deviate from the established rules was properly documented indicating what the basis of the deviation was, the auditor would note that a business decision was documented at step 29. In determining whether the business decision was appropriate at 33, the underwriter would review the guidelines to determine if the business decision to deviate from the established rules for the investigation fell within those guidelines. Assuming it did, the underwriter would score the investigation business decision as appropriate at 19.

If the underwriter had made the same decision but had not noted that he or she intentionally waved the required financial statement (i.e. failed to document business decision made), the investigative work-up would have been scored defective at step 31. Assuming a slightly different scenario where the applicant is a famous movie star, who is 76 years old. Any decision by the underwriter to forgo the need for validation of the financials would not fall within the guidelines noted above; and therefore, the investigative business decision would be scored as defective at 35.

It is to be understood that an investigation business decision defect is a type or species of investigation defect. Similarly, an underwriting business decision defect is a type of or species of underwriting decision defect. The further delineation as to scoring defects as business decision defects (such as at steps 35 and 45), provides more specific information as to the nature of the defect and is intended to facilitate training and tracking of job performance by the underwriters.

To further enhance the auditing process and provide more specific information on the audit of the underwriting process, a grading scale is utilized to grade the underwriter's performance. The scale ranges from 0-4. A score of zero is used to indicate the audit is not applicable in this case. A score of one indicates a “deficiency”, two indicates “requires improvement”, three indicates “meets guidelines” and four indicates “outstanding”.

A score of one or “deficiency” is intended to be applied to cases in which the underwriting defect is of sufficient severity to require immediate corrective action or retraining of the underwriter. A score of two or “requires improvement” is intended to be applied to cases in which the underwriting defect is less severe, does not require immediate corrective action but is the type to review during evaluations or general training. A score of three “meets guidelines” is the score to be applied to most of the underwriting decisions in which the underwriter demonstrated proper discretion and followed the rules and guidelines. A score of four “outstanding” is intended to be applied to those situations in which the underwriting process and decision utilized by the underwriter demonstrates sufficient creativity and sound judgment to merit positive recognition and which might be used for exemplary purposes.

In general, a score of one, “deficiency” is likely to be applied if the underwriter failed to follow the requirements or rules for the investigative work-up or the underwriting decision and failed to document that a business decision to do so was made, particularly if the requirement missed was important to the underwriting process. A score of two, “requires improvement” is likely to be applied if the underwriter documented a business decision to deviate from the requirements or rules for an investigative work-up or an underwriting decision, but the business decision and the resulting deviation from the rules was not within established guidelines, assuming the deviation from the rules does not demonstrate a significant lack of understanding of the underwriting process.

Applying the grading scale more specifically to the investigative work-up process, a score of one, deficiency, should be applied when an approval was made before all outstanding information on age or amount requirements was received or for failure to order the appropriate information (EKG's or attending physician's statements). A score of two, requires improvement, is to be applied when the underwriter ordered additional information or documentation when a final offer could have been made at one rate with an offer to reconsider at a lower rate upon supplying additional information. A score of three, meets guidelines, applies when the underwriter follows established guidelines in making an exception to the rules and documents what was given up and why. A score of four, outstanding, should be awarded when the underwriter demonstrates creativity during the underwriting process without impacting mortality.

After completing the audit of the investigative work-up, the auditor typically focuses on the appropriateness of the medical and non-medical underwriting decisions. Medical underwriting decisions relate to the medical history and any health factors which affect life expectancy, such as smoking. Non-medical underwriting decisions relate to non-medical risks which affect life expectancy, including hazardous occupations or avocations. The medical and non-medical underwriting decisions are deemed appropriate at step 21 if the offered rate, is within two tables of the reinsurer's standards or the reinsurer's norms as documented by its underwriting manual.

Referring to the previous example, assume the quoted rate varied from the company's underwriting manual (the “book rate”) by three tables, but all of the guidelines are met. The underwriter documents the decision made acknowledging the deviation from established rates and provides an appropriate rationale as to why the deviation was made. The auditor would determine at step 21 that the underwriting decision was not appropriate. The auditor would then determine that the business decision for deviating was documented at step 39 and would then determine that the decision was within guidelines at step 43. The auditor would then score the underwriting decision as appropriate or within guidelines.

If the underwriter did not document the deviation, the underwriting decision would be scored as defective at 41. If the underwriter documented the decision, but one of the guidelines was not met, (i.e. applicant over seventy five), then the business decision would be scored as defective at 45.

The same grading scale as utilized with the audit of the investigative work-up is preferably utilized with the auditing of the underwriting decisions. A score of zero indicates insufficient information was available to make a tentative or final offer. A score of one, “deficiency”, indicates that the decision differs from established guidelines by more than two tables or other established criteria without necessary documentation. A score of two, “requires improvement”, is used to indicate the underwriter overlooked some significant risk parameter but the result was a decision which differs by less than two tables or other established criteria. A score of three, “meets guidelines”, indicates that the decision by the underwriter complies with rules on criteria for deviation from standard rates or if a deviation exceeds the established criteria, the exception is documented as to what was given up and why and the exception falls within guidelines. A score of four, “outstanding”, is used to indicate that the underwriter demonstrates creativity during the underwriting process without impacting mortality.

The financial underwriting decisions may also be audited in accordance with the auditing process beginning at step 21. Financial underwriting decisions may be based on the financial underwriting rules of the reinsurer, as may be set forth in a manual or the like. Again if the underwriter makes an exception to the rules, the auditor checks to see if the exception was documented and if so whether the decisions was within the established guidelines. A 0-4 grading scale also is applicable to financial underwriting decisions.

A score of zero would apply to cases declined for reasons other than financial reasons or due to an absence of enough information in the file to make a final offer. A score of one, “deficiency”, is used to indicate that the amount authorized exceeds twice the established guidelines without sufficient documentation or reasoning. A score of two, “requires improvement”, is used to indicate that the amount authorized exceeds the established guidelines by fifty percent without sufficient documentation or reasoning. A score of three, “meets guidelines”, indicates that there was appropriate justification and documentation for the decision. A score of four, “outstanding”, indicates that the underwriter demonstrated creativity during the underwriting process without impacting mortality.

Other aspects of the life insurance underwriting decision process are not necessarily audited using the process shown in FIG. 2. Rather, in view of the nature of the decision, these aspects are simply evaluated as to whether the underwriter followed the rules or not.

One such aspect is the underwriter's decision on whether to obtain a second opinion for EKG's. For example, the reinsurer's rules might provide that for applicant's aged 80 or younger and for underwriters who can interpret EKG's, a doctor should be consulted when the amount of coverage sought is greater than the lesser of the underwriter's signature authority or $10,000,000. For applicants ages 81 and older, the EKG should be referred to a doctor for all applicants. For underwriters who cannot interpret EKGs, a doctor's interpretation of all pertinent EKGs should be included in the file. If the underwriter feels that the EKG is not within normal limits, a doctor's review or discussion should be documented in the file if the face amount is $5,000,000 or more.

The auditor will also consider whether the underwriter followed requirements as to when to obtain second signatures. For example, the reinsurer may require a second signature from another underwriter when the case exceeds the original underwriter's approval authority. Similarly the auditor will also consider whether the underwriter followed all retrocession rules as documented in the reinsurer's retrocession treaties. In addition, the auditor will determine whether the underwriter took appropriate notes for the file, whether the underwriter properly prepared all supporting correspondence and memos, and whether the underwriter satisfied any customer requests as to timeliness of handling the underwriting process.

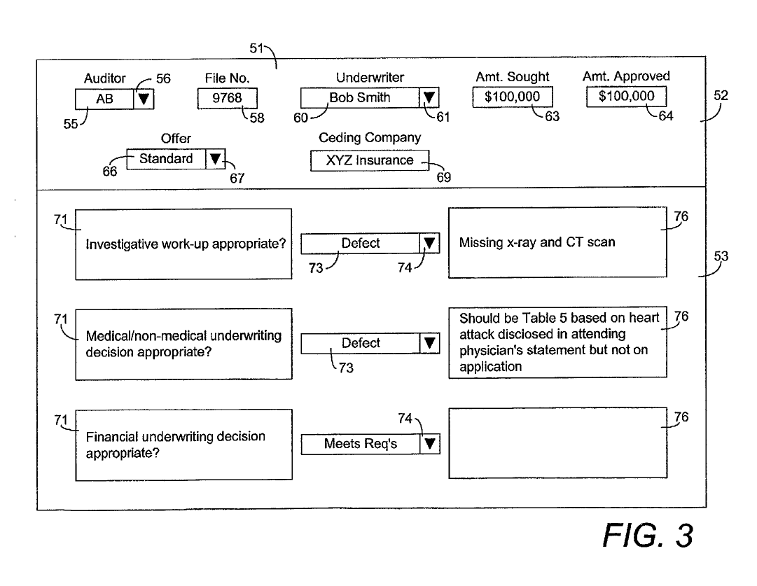

FIG. 3 discloses a data collection screen 51 for use in recording the results or scores of the underwriting process in a database. The screen is generally divided into two sections, an identification section 52 for inputting or recording pertinent information to identify the file to be audited, and a scoring section 53 to record the auditor's scores and comments relating to the underwriting process.

The identification section 52 includes an auditor box 55 is provided to fill in identifying information for the auditor, such as initials as shown in FIG. 3. The box may include a drop-down selection feature or button 56 to allow the user to select an auditor from a list of auditors. A file box 58 is provided to allow a user to fill in identifying information for the file to be audited such as a file number.

An underwriter box 60 is provided to allow a user to fill in the name of the underwriter who handled the file. A drop down selection feature 61 is provided to permit the user to select the name of the underwriter from a listing of underwriters. An amount sought box 63 is provided to record the amount of insurance sought by the applicant and an amount approved box 64 is provided to record the amount of coverage approved. An offer box 66 is provided to permit the user to indicate how the underwriter rated the file, such as “standard”, “table 2” (or any other table rating), or “declined”. Box 66 also includes a drop down selection button 67 to permit the user to select from a listing of ratings. A cedant box 69 is also provided to indicate the name of the customer or client, which in the case of reinsurance, will be a primary insurance company.

The data collection screen 51 may be associated with a computer program, which functions to fill in the identifying information regarding the file to be audited, such as the information in boxes 60, 63, 64, 66 and 69, upon inputting of the file number in file box 58.

The scoring section 53 of the data collection screen 51 generally is divided into three columns or sections. The first column or section includes descriptive indications 71 of a specific auditing inquiry. The auditing inquiries shown in FIG. 3 include: whether the investigative work-up was appropriate; whether the medical/non-medical underwriting decision was appropriate; and whether the financial underwriting decision was appropriate. It is to be understood that the other audit inquiries discussed above could also be listed in the scoring section 53 of the data collection screen 51.

The second column or section includes an audit score box 73 in which the auditor may fill in the assigned score associated with the audit inquiry referred to in the descriptive indication 71 in the same row of the first column. Audit score box 73 preferably includes a drop down selection button 74 to permit the user to select from a listing of the scores. As discussed previously, the scores to choose from include “not applicable”, “defective” or “defect”, “needs improvement”, “meets requirements” and “outstanding”. It is to be understood that the scores may be recorded as the word descriptions just described or by the corresponding numerical value associated therewith. In addition, the “defect” scores may be further delineated to identify a defect as a defect in a business decision. Alternatively a separate descriptive indication 71 could be provided for business decisions and scores for the overall business decisions could be tracked separately.

The third column comprises comment boxes 76 which are associated with the descriptive indication 71 and score box 73 in the same row. The auditor is instructed to provide explanatory comments which provide a basis for the score provided. Explanatory comments typically are not required or provided for steps scored as meeting requirements.

The information recorded on the screen 51, is saved to a database and the information collected thereby may be used to generate reports to track the number and nature of defects by individuals or the group as a whole. The data may be manipulated in various ways known in the art to produce the desired report with the appropriate information. For example, the performance of individual underwriters could be compared versus the performance of other underwriters by comparing the number of defects by an underwriter versus the total number of files reviewed by that underwriter. Comparisons could also be made between types of defects, such as investigation defects and underwriting decision defects. Reports can also be generated to track whether defects increase or decrease over time. Reports can be generated to determine the frequency of different types of defects. The information compiled from the database can then be used to identify individuals needing further training or guidance or underwriting procedures which need more attention in training.

It is to be understood that while certain embodiments of the present invention have been illustrated and described herein, it is not to be limited to the specific processes or arrangement of steps described and shown. In particular it is to be understood that the audit process described above could be used in various forms in association with other types or lines of insurance.

What is claimed is:

1. A process for auditing underwriting decisions made by an underwriter relating to an application to an insurer for insurance, said process comprising the steps of:
obtaining a file documenting the underwriting decision of the underwriter;
reviewing the underwriting decision;
determining whether the underwriting decision deviates from rules for underwriting established by the insurer;
upon a determination that the underwriting decision does not deviate from the rules, scoring the underwriting decision as appropriate;
upon a determination that the underwriting decision does deviate from the rules, determining whether the underwriter made a business decision to deviate from the rules and whether the underwriter documented that a business decision to deviate from the rules was made;
upon a determination that the underwriter did not document that a business decision to deviate from the rules was made, scoring the underwriting decision as defective;
upon a determination that the underwriter documented that a business decision to deviate from the rules was made, determining whether the business decision was within established guidelines for the insurer;
upon a determination that the business decision was not within established guidelines for the insurer, scoring the business decision as defective; and
upon a determination that the deviation was within established guidelines for the insurer, scoring the underwriting decision as appropriate.

2. A process for auditing investigations conducted by an underwriter relating to an application to an insurer for insurance, said process comprising the steps of:
obtaining a file documenting the investigation conducted by the underwriter;
reviewing the investigation conducted by the underwriter;
determining whether the underwriter deviated from established requirements for the investigation established by the insurer;
upon a determination that the underwriter did not deviate from established requirements for the investigation, scoring the investigation as appropriate;
upon a determination that the underwriter deviated from established requirements for the investigation, determining whether the underwriter made a business decision to deviate from the established requirements for the investigation and whether the underwriter documented the business decision;
upon a determination that the underwriter did not document the business decision to deviate from the established requirements for the investigation, scoring the investigation as defective;
upon a determination that the business decision to deviated from the established requirements for the investigation was documented, determining whether the business decision was within established guidelines for the insurer;
upon a determination that the business decision to deviate from the established requirements for the investigation was not within established guidelines, scoring the investigation business decision as defective; and
upon a determination that the business decision to deviate from the established requirements for the investigation was within established guidelines, scoring the investigation as appropriate.

3. A process for auditing an underwriting process of an underwriter relating to an application to an insurer for insurance; the underwriting process including an investigation conducted by the underwriter and an underwriting decision made by the underwriter; the auditing process comprising the steps of:
obtaining a file documenting the investigation conducted by the underwriter and documenting the underwriting decision made by the underwriter;
reviewing the investigation conducted by the underwriter; determining whether the underwriter deviated from established requirements for the investigation established by the insurer;
upon a determination that the underwriter did not deviate from established requirements for the investigation, scoring the investigation as appropriate;
upon a determination that the underwriter deviated from established requirements for the investigation, determining whether the underwriter made a business decision to deviate from the established requirements for the investigation and whether the underwriter documented the business decision;
upon a determination that the underwriter did not document the business decision to deviate from the established requirements for the investigation, scoring the investigation as defective;
upon a determination that the business decision to deviated from the established requirements for the investigation was documented, determining whether the business decision was within established guidelines for the insurer;
upon a determination that the business decision to deviate from the established requirements for the investigation was not within established guidelines, scoring the investigation business decision as defective; and
upon a determination that the business decision to deviate from the established requirements for the investigation was within established guidelines, scoring the investigation as appropriate;
reviewing the underwriting decision;
determining whether the underwriting decision deviates from rules for underwriting established by the insurer;
upon a determination that the underwriting decision does not deviate from the rules, scoring the underwriting decision as appropriate;
upon a determination that the underwriting decision does deviate from the rules, determining whether the underwriter made a business decision to deviate from the rules and whether the underwriter documented that a business decision to deviate from the rules was made;
upon a determination that the underwriter did not document that a business decision to deviate from the rules was made, scoring the underwriting decision as defective;
upon a determination that the underwriter documented that a business decision to deviate from the rules was made, determining whether the business decision was within established guidelines for the insurer;
upon a determination that the business decision was not within established guidelines for the insurer, scoring the business decision as defective; and
upon a determination that the deviation was within established guidelines for the insurer, scoring the underwriting decision as appropriate.

4. A process for auditing underwriting decisions relating to an application to an insurer for insurance, the underwriting decision comprising a decision as to a rating to be associated with the insurance based upon an evaluation of identified risks factors associated therewith, said process comprising the steps of:
obtaining a file documenting the underwriting decision of the underwriter;
reviewing the underwriting decision;
determining whether the rating under which insurance coverage was offered pursuant to the underwriting decision deviates from an acceptable range of ratings established by the insurer based upon the identified risk factors;
upon a determination that a deviation did not occur, scoring the underwriting decision as appropriate;
upon a determination that a deviation did occur, determining whether the underwriter documented in the file that a deviation occurred and the basis for the deviation;
upon a determination that the deviation was not documented, scoring the underwriting decision as defective;
upon a determination that the deviation was documented, determining whether the deviation was within established guidelines for the insurer;
upon a determination that the deviation was not within established guidelines for the insurer, scoring the underwriting decision as defective; and
upon a determination that the deviation was within established guidelines for the insurer, scoring the underwriting decision as appropriate.

5. The process for auditing underwriting decisions as in claim 4 wherein the step of scoring the underwriting decision as defective includes differentiating between defective underwriting decisions which require prompt remedial action and those which do not.

6. The process for auditing underwriting decisions as in claim 4 wherein the step of scoring the underwriting decision as appropriate includes differentiating between appropriate underwriting decisions which merit recognition and those which do not.

7. A process for auditing an underwriting process of an underwriter relating to an application to an insurer for insurance, the underwriting process including an investigation conducted by the underwriter to identify risks associated with the insurance, said process comprising the steps of:
obtaining of a file documenting the investigation conducted by the underwriter;
reviewing of the investigation conducted by the underwriter;
determining whether the underwriter deviated from established requirements for the investigation established by the insurer;
upon a determination that the underwriter did not deviate from established requirements for the investigation, scoring the investigation as appropriate;
upon a determination that the underwriter deviated from established requirements for the investigation, determining whether the underwriter documented in the file the deviation and the basis for the deviation;
upon a determination that the deviation in the investigation was not documented, scoring the investigation as defective;
upon a determination that the deviation in the investigation was documented, determining whether the deviation was within established guidelines for the insurer;
upon a determination that the deviation in the investigation was not within established guidelines, scoring the investigation as defective; and
upon a determination that the deviation in the investigation was within established guidelines, scoring the investigation as appropriate.

8. The process for auditing an underwriting process as in claim 7 wherein the step of scoring the investigation as defective includes differentiating between defective investigations which require prompt remedial action and those which do not.

9. The process for auditing an underwriting process as in claim 7 wherein the step of scoring the investigation as appropriate includes differentiating between appropriate investigations which merit recognition and those which do not.

10. A process for auditing an underwriting process of an underwriter relating to an application to an insurer for insurance, the underwriting process including an investigation conducted by the underwriter to identify risks associated with the insurance and an underwriting decision as to terms under which to offer the insurance based upon an evaluation of the identified risks associated with the insurance, said auditing process comprising the steps of:
obtaining a file documenting the investigation conducted by the underwriter and documenting the underwriting decision;
reviewing the investigation conducted by the underwriter;
determining whether the underwriter deviated from established requirements for the investigation established by the insurer;
upon a determination that the underwriter did not deviate from established requirements for the investigation, scoring the investigation as appropriate;
upon a determination that the underwriter deviated from established requirements for the investigation, determining whether the underwriter documented in the file the deviation and the basis for the deviation;
upon a determination that the deviation in the investigation was not documented, scoring the investigation as defective;
upon a determination that the deviation in the investigation was documented, determining whether the deviation was within established guidelines for the insurer;
upon a determination that the deviation in the investigation was not within established guidelines, scoring the investigation business decision as defective;
upon a determination that the deviation in the investigation was within established guidelines, scoring the investigation as appropriate;
reviewing the underwriting decision;
determining whether the financial terms under which the insurance was offered pursuant to the underwriting decision deviates from an acceptable range of financial terms established by the insurer;
upon a determination that a deviation did not occur, scoring the underwriting decision as appropriate;
upon a determination that a deviation did occur, determining whether the underwriter documented in the file the deviation and the basis for the deviation;
upon a determination that the deviation was not documented, scoring the underwriting decision as defective;
upon a determination that the deviation was documented, determining whether the deviation was within established guidelines of the insurer;
upon a determination that the deviation was not within established guidelines of the insurer, scoring the underwriting business decision as defective; and
upon a determination that the deviation was within established guidelines for the insurer, scoring the underwriting decision as appropriate.

11. The process for auditing an underwriting process as in claim 10 wherein the step of scoring the investigation as defective includes differentiating between defective investigations which require prompt remedial action and those which do not; and the step of scoring the underwriting decision as defective includes differentiating between defective underwriting decisions which require prompt remedial action and those which do not.

12. The process for auditing underwriting decisions as in claim 10 wherein the step of scoring the investigation as appropriate includes differentiating between appropriate investigations which merit recognition and those which do not; and the step of scoring the underwriting decision as appropriate includes differentiating between appropriate underwriting decisions which merit recognition and those which do not.
